(19) United States
(12) Patent Application Publication
(10) Pub. No.: US 2009/0125310 A1
(43) Pub. Date: May 14, 2009

(54) APPARATUS AND METHOD FOR INSERTING/EXTRACTING CAPTURING RESISTANT AUDIO WATERMARK BASED ON DISCRETE WAVELET TRANSFORM, AUDIO RIGHTS PROTECTION SYSTEM USING THE SAME

(76) Inventors: Seungjae Lee, Cheonan (KR); Sang Kwang Lee, Daejeon (KR); Jin Soo Seo, Daejeon (KR); Young Ho Suh, Daejeon (KR); Yong Seok Seo, Daejeon (KR); Seon Hwa Lee, Daejeon (KR); Won Gyum Kim, Daejeon (KR); Wonyoung Yoo, Daejeon (KR); Sung Hwan Lee, Daejeon (KR); Hye Won Jung, Daejeon (KR); Young Suk Yoon, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/298,994

(22) PCT Filed: Jun. 11, 2007
(86) PCT No.: PCT/KR2007/002803

§ 371 Date: Oct. 29, 2008

(30) Foreign Application Priority Data
Jun. 21, 2006 (KR) 10-2006-0055953

(51) Int. Cl. G10L 21/00

(52) U.S. Cl. 704/273; 704/E21.001

(57) ABSTRACT

An apparatus and method for embedding and extracting a capturing-resistant audio watermark based on discrete wavelet transform, and a copyright management system using the same are provided. The apparatus for embedding a wavelet based audio watermark includes: a framing unit for dividing an input audio signal into small signals with a regular length; a discrete wavelet transform unit for calculating an mean value of wavelet coefficients by transforming the small signals based on a discrete wavelet transform; and an embedding unit for changing the calculated mean value according to a watermark where a synchronization signal is inserted and inserting the watermark into the audio signal.

### TECHNICAL FIELD

The present invention relates to an apparatus and method for embedding and extracting a capturing-resistant audio watermark based on discrete wavelet transform, and a copyright management system using the same; and more particularly, to a copyright protection scheme for audio contents, which embeds a capturing-resistant watermark including user information in an audio content, and extracts the capturing-resistant watermark and uses the user information included in the extracted watermark when a digital rights management (DRM) packaged audio content is captured after passing a copyright authentication process and the captured audio content is illegally duplicated and distributed.

### BACKGROUND ART

Encryption based digital rights management (DRM) is a copyright protection and management scheme that encodes files and gives a right to only an authenticated user to decode the coded files. However, the encryption based DRM cannot prevent the copyright infringement made by a capturing attack after passing an authentication process. In order to overcome such a shortcoming of the encryption based DRM, a conventional watermarking method for protecting the copyright was introduced. The watermarking method embeds a watermark having user information in digital contents, and traces a person who illegally distributes the digital contents based on the user information in the watermark when the digital contents are illegally distributed.

However, conventional audio watermarking methods cannot accurately extract the user information due to various distortions, sampling rate conversion, compression, format conversion and filter.

A method of amplitude-scaling resilient audio watermarking by quantizing audio frequency component is disclosed in Korean Patent Publication No. 2005-0020040 (Application No. 2003-0057682). Although this conventional method is robust against lossy compression or amplitude variation, which may occur during capturing audio contents, it is weak in sampling variation.

A method for protecting the copyright of video content by embedding a watermark into video content when the video content is reproduced is disclosed in Korean Patent Publication No. 2006-0017420 (Application No. 2004-0066085). That is, it is a copyright protection and tracking method for video content. However, the present invention relates to a capturing resistant audio watermarking method that protects the copyright of audio contents by embedding the capturing resistant watermark into an audio content when the audio content is reproduced.

A conventional method of automatically synchronizing using discreet wavelet transform (DWT) was introduced in an article by S. Wu, J. Huang, D. Huang, and Y. Q. Shi, entitled “Self-synchronized audio watermarking in DWT domain”, in Proc. IEEE Int. Sym. On Circuits and Systems, vol. 5, pp. 712-715, May 2004. This article teaches the method of extracting a watermark although a watermarked signal loses a synchronization point. Differently from the conventional method, the apparatus and method for embedding and extracting a capturing-resistant watermark according to the present invention embeds an artificial synchronization signal into an audio content when a watermark is embedded, and uses the inserted artificial synchronization signal with a synchronization detecting function for the synchronization.

### DISCLOSURE OF INVENTION

### Technical Problem

It is an object of the present invention to provide an apparatus and method for embedding a wavelet based watermark robust against lossy compression by embedding a watermark by changing the mean of lowest subband coefficients according to a watermark by transforming an audio signal based on discrete wavelet transform (DWT).

It is another object of the present invention to provide an apparatus and method for embedding a wavelet based watermark for providing the inaudibility of a watermark by controlling a degree of embedding power after applying an audio signal and a discrete wavelet transformed signal to a human auditory model.

It is still another object of the present invention to provide an apparatus and method for embedding a wavelet based watermark for providing a robust characteristic against synchronization point loss by inserting an artificial synchronization signal when a watermark is embedded and using a synchronization detecting function.

### Technical Solution

To achieve these objects and other advantages and in accordance with the purpose of the invention, as embodied and broadly described herein, there is provided an apparatus for embedding a wavelet based audio watermark, including: a framing unit for dividing an input audio signal into small signals with a regular length; a discrete wavelet transform unit for calculating an mean value of wavelet coefficients by transforming the small signals based on a discrete wavelet transform; and an embedding unit for changing the calculated mean value according to a watermark where a synchronization signal is inserted and inserting the watermark into the audio signal.

The apparatus may further include a human auditory model unit for controlling an insertion level of the watermark using the input audio signal and the discrete wavelet transformed signal.

The apparatus may further include an encoding unit for inserting an additional signal to the watermark and transferring the watermark with the additional signal to the embedding unit in order to detect a synchronization of a watermark.

In another aspect of the present invention, there is provided an apparatus for extracting a watermark based on a discrete wavelet transform including: a synchronization unit for receiving an audio signal with a watermark inserted and searching a synchronization point; an extracting unit for extracting inserted information using a mean value of wavelet coefficients by wavelet transform of an audio signal having the watermark of the searched synchronization point; and a decoding unit for decoding a watermark using the extracted information.

The mean of the wavelet coefficients in the extracting unit may be a mean of lowest subband wavelet coefficients.

The synchronization unit may search a synchronization point using information of adjacent frame, and the information of the adjacent frame may be information about combination of a mean and variance

The decoding of the watermark may extract a watermark using difference information of extracted values between adjacent frames.

In still another aspect of the present invention, there is provided a method for extracting a wavelet based audio watermark including the steps of: a) dividing input audio signal into small signals with a regular length; d) calculating a mean value of wavelet coefficients by performing a discrete wavelet transform on the small signals; and c) inserting a watermark in the audio signal by changing the calculated mean value of discrete wavelet coefficients.

The step c) may include the step of c-1) controlling a degree of embedding the watermark using the input audio signal and the discrete wavelet transformed signal.

The method may further include the step of d) inserting an additional signal into the watermark for detecting a synchronization of the inserted watermark, and transferring the watermark to the step c).

In further still another aspect of the present invention, there is provided a method for extracting a wavelet based audio watermark including the steps of: a) receiving a watermarked audio signal and searching a synchronization point; b) extracting inserted information from the watermarked audio signal using a mean of wavelet coefficients by discrete wavelet transform of the watermarked audio signal having the searched synchronization point; and c) decoding a watermark using the extracted information.

In the step a), the synchronization point may be searched using information about adjacent frames.

The mean of the wavelet coefficients in the step a) may be a mean of lowest subband wavelet coefficients.

In the step c), the watermark may be extracted using difference information of extracted values between adjacent frames.

In even still further another aspect of the present invention, there is provided a copyright management system using an apparatus for embedding and extracting a wavelet based audio watermark, including: a watermark embedding apparatus for embedding the watermark into the audio signal by changing a mean value of wavelet coefficients according to a watermark by performing a discrete wavelet transform on an audio signal which is divided into small signals with a regular length; and a watermark extracting apparatus for searching a synchronization point of a watermarked audio signal, extracting inserted information using a mean of wavelet coefficients by wavelet transforming the watermarked audio signal, and decoding a watermark using the extracted information.

### ADVANTAGEOUS EFFECTS

An apparatus and method for embedding and extracting a capturing-resistant audio watermark based on discrete wavelet transform according to the present invention and a copyright managing system using the same can extract a watermark after capturing because it is robust against various distortions that may be made during capturing. Also, the apparatus and method according to the present invention inserts user information into an audio content as a watermark when a DRM packaged audio content is reproduced. Therefore, the copyright of the audio contents can be protected by tracking an illegal distributor using the user information included in the watermark when the audio content is illegally duplicated and distributed. The introduced audio watermarking method according to the present invention uses the simple human auditory model. Also, in order to find a synchronization point, a mean value is made to zero when the watermark is inserted, and a detection function is used. Therefore, the inaudibility of the watermark is achieved and the synchronization point can be detected easily.

The capturing resistant characteristic may be confirmed through experimental results in below tables. The capturing resistant characteristics for sampling rate variation, synchronization loss and compression, which are representative distortions generated during capturing, are confirmed, and then, a watermark is inserted while capturing a DRM packaged file for various types of capturing attacks.

As shown in Tables 1 and 2, the strong capturing-resistant characteristics are shown, and the extraction may fail according to a network environment or a system performance. It is expected that the extraction may fail rarely if experimental results are obtained from a sufficiently longer region using a longer file, as like as the real service, compared to a length of a file used at a test.

Also, as an inaudibility test, a preference test is performed using a watermarked file and a file without a watermark. As shown in Table 3, a user cannot recognize different two files. Therefore, the inaudibility characteristic can be provided by the present invention.

TABLE 1
capturing-resistant test

| | cropping¹ | compression² | resampling³ | capturing⁴ |
|---|---|---|---|---|
| classic | 100% | 100% | 100% | 100% |
| ballad | 100% | 100% | 100% | 100% |
| dance | 100% | 100% | 100% | 100% |
| rock | 100% | 100% | 100% | 87.5% |
| avg. | 100% | 100% | 100% | 96.8% |

¹extracted at a random location,
²extracted after compressing into MP3 at 128 kbps,
³extracted after re-sampling at 32 kHZ,
⁴extracted after capturing as MP3 32 kHz at 128 kbps.

TABLE 2
capturing-resistant test

| | capturing¹ | capturing² | capturing³ | capturing⁴ |
|---|---|---|---|---|
| DRM1 | 94.4% | 100% | 100% | 100% |
| DRM2 | 100% | 99.4% | 99.4% | 100% |
| DRM3 | 100% | 100% | 100% | 94.4% |
| DRM4 | 100% | 99.4% | 100% | 100% |
| DRM5 | 100% | 100% | 88.9% | 100% |

¹capturing as MP3 128 kbps 44.1 kHz,
²capturing as MP3 128 kbps 32 kHz,
³capturing as MP3 128 kbps 48 kHz, and
⁴capturing WMA 96 kbps 44.1 kHz.

TABLE 3
inaudibility test

| | A > B | A = B | A < B |
|---|---|---|---|
| classic | 33.3% | 50% | 16.7% |
| ballad | 50% | 50% | 0% |
| dance | 16.7% | 66.6% | 16.7% |
| rock | 50% | 33.3% | 16.7% |
| avg. | 37.5% | 50% | 12.5% |

A: original file, B: watermarked file

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings;

FIG. 1 is a block diagram illustrating in accordance with the present invention;

FIG. 2 is a block diagram illustrating an apparatus for extracting a wavelet based audio watermark according to an embodiment of the present invention;

FIG. 3 is a view for describing a watermark encoding operation according to an embodiment of the present invention;

FIG. 4 is a graph of a synchronization signal detecting function;

FIG. 5 shows a different histogram between extracted watermark signals;

FIG. 6 is a state diagram for decoding a watermark; and

FIG. 7 is a block diagram showing a DRM client module according to an embodiment of the present invention.

### BEST MODE FOR CARRYING OUT THE INVENTION

Reference will now be made in detail to the preferred embodiments of the present invention, examples of which are illustrated in the accompanying drawings

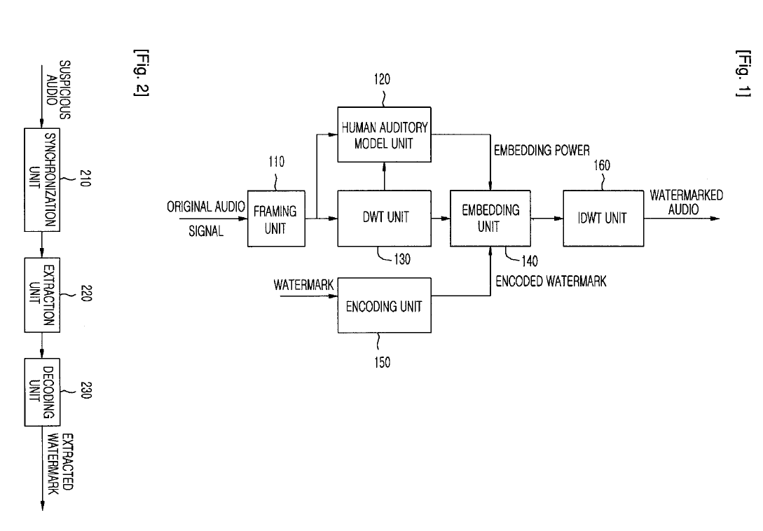

FIG. 1 is a block diagram illustrating an apparatus for inserting a wavelet based audio watermark according to an embodiment of the present invention.

Referring to FIG. 1, the wavelet based audio watermark apparatus according to the present embodiment includes a framing unit 110 for dividing an original audio signal into small sized frames, a discrete wavelet transform (DWT) unit 120 for transforming the divided audio frames based on discrete wavelet transform (DWT), a human auditory model 130 for deciding a degree of embedding a watermark by applying the original signal and the discrete wavelet transformed audio frames to a human auditory model, an encoding unit for encoding a watermark in order to enhance the performance of synchronization and detection, an embedding unit 140 for embedding a watermark by changing an mean of lowest subband coefficients based on the DWT using a watermark block created through encoding, and an inverse discrete wavelet transform (IDWT) unit 160 for restoring the watermarked original audio signal by applying IDWT.

The framing unit 110 divides an original audio signal into small sized frames in order to embed a watermark in the original audio signal. The discrete wavelet transform (DWT) is applied using the divided audio frames from the framing unit 110.

The DWT unit 130 may use one of well-known wavelet filters.

The DWT divides a signal into a low-band signal and a high-band signal using a wavelet filter as shown in a below diagram, where H[n] denotes a high pass filter, and G[n] denotes a low pass filter. The signal can be disassembled with a low band signal with a center, and the disassembled signal can be restored into the original signal through the inverse DWT. The below diagram shows two steps of DWT.

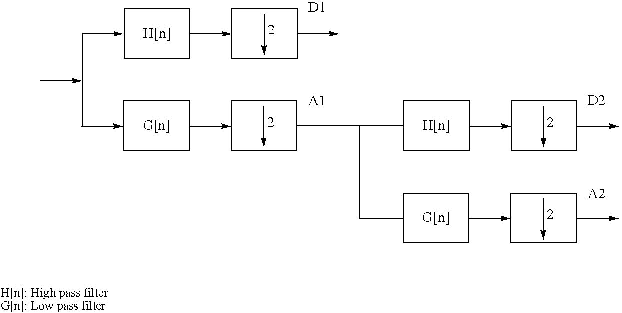

### <Example of DWT>

In the present embodiment, a watermark is embedded into an audio signal by changing a mean value of lowest subband coefficients using the DWT.

The human auditory model unit 120 decides a degree of embedding a watermark after applying the human auditory model using the original audio signal and the DWT applied signal.

The human auditory model unit 120 controls the degree of embedding the watermark using the ratio between the energy S1 of the input audio signal and the energy S2 of a high frequency signal in a lowest subband coefficient of the DWT. In this case, inaudibility can be obtained by controlling the degree of embedding the watermark according to the input signal. Also, using the human auditory model with the original audio signal and the discrete wavelet transformed audio signal requires less computation amount compared to the human auditory model used in the conventional MP3.

The encoding unit 150 encodes the watermark before inserting the watermark in order to enhance the performance of detecting a synchronization signal and a watermark.

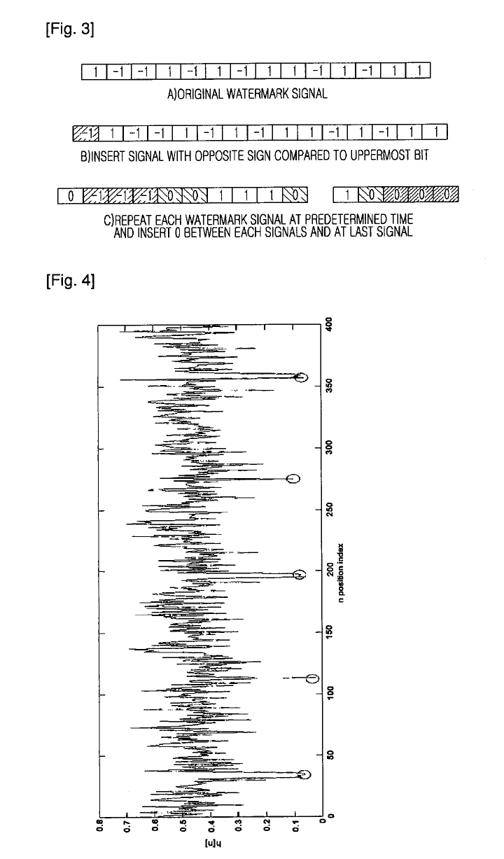

The operation of encoding the watermark will be described with reference to FIG. 3.

An original watermark is expressed as 1 and −1, and these are mapped to a bit 1 and a bit 0, respectively.

The encoding unit 150 inserts a bit having a different sign compared to the uppermost bit of the original watermark signal (a) as shown in (b) of FIG. 3. Then, each of watermark signals is repeated n times, and 0 is inserted between inserted data to prevent data from being interfered by others. Also, a watermark block denoting one user information is repeatedly inserted, and 0 is repeatedly inserted between the watermark blocks in order to distinguish the watermark blocks of one user information from others and to find a synchronization point as shown in (c) in FIG. 3.

The embedding unit 140 embeds the encoded watermark block from the encoding unit 150 using the decided inserting degree decided by the human auditory model unit 120 by changing a mean of lowest subband coefficients transformed by DWT at the DWT unit 130.

The mean of lowest subband coefficients changes according to the information of the encoded watermark.

If the information of the encoded watermark is 1, the mean value changes to a positive value, and if the information of the encoded watermark is −1, the mean value changes to a negative value. The changing of the mean of the lowest subband coefficients can be expressed as a below equation.

$${C}_{m}^{k} [ n ] = \{ \begin{matrix}{C}_{o}^{k} [ n ] - ( 2 m - {P}_{a}^{k} ) \cdot H [ n ] & if {w}_{e} = 1 \\ {C}_{o}^{k} [ n ] - ( 2 m + {P}_{a}^{k} ) \cdot H [ n ] & if {w}_{e} = - 1 \\ {C}_{o}^{k} [ n ] - 2 m \cdot H [ n ] & if {w}_{e} = 0\end{matrix}$$

### Mode for the Invention

Cₘ^{k}[n]

denotes a n^{th} coefficient value of a transformed k^{th} frame.

,Cₒ^{k}[n]

denotes a n^{th} coefficient of a k^{th} original frame. m denotes an mean value of k^{th} frame. Pₐ^{k} denotes an insertion level of a k^{th} frame. H[n] denotes a window function.

The inverse discrete wavelet transform (IDWT) unit 160 restores an original signal with a watermark inserted by transforming watermarked frames based on the IDWT.

FIG. 2 is a block diagram illustrating an apparatus for extracting a wavelet based audio watermark according to an embodiment of the present invention.

The wavelet based audio watermark extracting apparatus according to the present invention includes a synchronization unit 210 for finding a synchronization point, an extraction unit 220 for extracting inserted information when a synchronization point is selected, and a decoding unit 230 for decoding a watermark using the extracted information.

The synchronization unit 210 finds a synchronization point using a 0 signal which is used for encoding the watermark. The synchronization unit 210 finds a synchronization point using characteristics that the mean value of the lowest subband wavelet coefficients between adjacent frames is close to 0 at the synchronization point. The synchronization unit 210 uses a function h[n], which uses the sum and variance of the adjacent frames in order to extract a synchronization which is less effected by various variations such as noises.

h[n]=α*f[n]+β*g[n]

α

and

β

denote weights, f[n] denotes a wavelet coefficient mean of adjacent N frames, and g[n] denotes a wavelet coefficient variance of adjacent N frames. FIG. 4 is a graph of a synchronization signal detecting function h[n]. As shown in FIG. 4, h[n] outputs a minimum value at about a synchronization point. It can be used as the synchronization point.

The extraction unit 220 calculates a mean value of lowest subband coefficients of DTF for each frame of each audio signal through DTF using the same method for inserting the watermark after selecting the synchronization point by the synchronization unit 210. According to its sign, the inserted information is extracted. At first, a middle value of the repeated values is extracted from the repeatedly inserted data. This information is sensitive to noise or amplitude variation. On the contrary, since the difference between adjacent frames is less sensitive to peripheral environment, the watermark is extracted using the difference information.

Also, the extracted value is normalized by estimating a degree of embedding a watermark is estimated from a signal to extract. Although the estimated embedding degree is different from a real embedding degree used to insert the watermark, small variation may be made after inserting a watermark. That is, large variation is not made because of using a ratio between the energy of the original signal and a high band coefficient among wavelet coefficient.

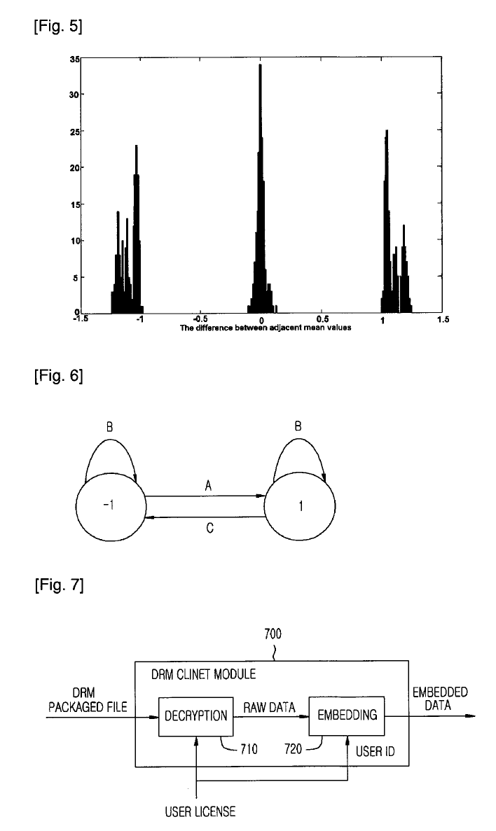

FIG. 5 shows a different histogram between extracted watermark signals. FIG. 5 shows that values corresponding to the difference between the inserted values are clearly separated. The extraction unit 220 transfers the information about the difference to the decoding unit 230.

The decoding unit 230 restores a watermark using information extracted by the extraction unit 220. The decoding unit 230 restores a watermark using information related to the difference of the extraction unit 220. That is, the decoding unit 230 restores information about 1 and −1 of the original watermark using values corresponding to the difference of the extraction unit 220. FIG. 6 is a state diagram for decoding a watermark. The relation of different information is expressed as a, b, and c using values corresponding to the difference that is clearly shown as separated in FIG. 5, and the original information 1 and −1 is obtained.

In order to accurately extract a watermark, it is preferable to use a mean value between frames by gathering several watermark blocks. Using the mean value can prevent failure of information extraction because information is lost during capturing or noise is inserted during capturing.

FIG. 7 is a block diagram showing a DRM client module according to an embodiment of the present invention. When an audio content is illegally distributed, an illegal distributor can be tracked using user information inserted in the audio content.

The DRM client module 700 includes a decryption unit 710 for assigning a user license to access an encoded file through an authentication process when a DRM packaged file inputs, and an embedding unit 720 for embedding information about a user such as User ID to raw data with the access right assigned.

As described above, supplementary information with the user information is inserted into an audio content as a watermark at the moment of releasing the encryption according to the present invention. Therefore, the copyright of the audio content can be conveniently protected by tracking an illegal distributor using user information included in the audio content when the audio content is illegally duplicated and distributed.

It will be apparent to those skilled in the art that various modifications and variations can be made in the present invention. Thus, it is intended that the present invention covers the modifications and variations of this invention provided they come within the scope of the appended claims and their equivalents.

1. An apparatus for embedding a wavelet based audio watermark, comprising:
a framing unit for dividing an input audio signal into small signals with a regular length;
a discrete wavelet transform unit for calculating an mean value of wavelet coefficients by transforming the small signals based on a discrete wavelet transform; and
an embedding unit for changing the calculated mean value according to a watermark where a synchronization signal is inserted and inserting the watermark into the audio signal.

2. The apparatus of claim 1, wherein the mean value of the wavelet coefficients of the discrete wavelet transform unit is an mean value of lowest subband coefficients.

3. The apparatus of claim 1, further comprising a human auditory model unit for controlling an insertion level of the watermark using the input audio signal and the discrete wavelet transformed signal.

4. The apparatus of claim 3, wherein the human auditory model unit controls an insertion level using a ratio of an energy of the audio signal and an energy of a high frequency signal in a minimum coefficient by discrete wavelet transform.

5. The apparatus of claim 1, further comprising an encoding unit for inserting an additional signal to the watermark and transferring the watermark with the additional signal to the embedding unit in order to detect a synchronization of a watermark.

6. The apparatus of claim 5, wherein the encoding unit arranges the watermark repeatedly and inserts an additional signal between the repeatedly arranged watermarks.

7. An apparatus for extracting a watermark based on a discrete wavelet transform comprising:
a synchronization unit for receiving an audio signal with a watermark inserted and searching a synchronization point;
an extracting unit for extracting inserted information using a mean value of wavelet coefficients by wavelet transform of an audio signal having the watermark of the searched synchronization point; and
a decoding unit for decoding a watermark using the extracted information.

8. The apparatus of claim 7, wherein the synchronization unit searches a synchronization point using information of adjacent frame.

9. The apparatus of claim 8, wherein the information of the adjacent frame is information about combination of a mean and variance.

10. The apparatus of claim 7, wherein the mean of the wavelet coefficients in the extracting unit is a mean of lowest subband wavelet coefficients.

11. The apparatus of claim 7, wherein the decoding of the watermark extracts a watermark using difference information of extracted values between adjacent frames.

12. The apparatus of claim 7, wherein the watermark is extracted using a mean of frames by gathering a plurality of watermark blocks.

13. A method for extracting a wavelet based audio watermark comprising the steps of:
a) dividing input audio signal into small signals with a regular length;
b) calculating a mean value of wavelet coefficients by performing a discrete wavelet transform on the small signals; and
c) inserting a watermark in the audio signal by changing the calculated mean value of discrete wavelet coefficients.

14. The method of claim 13, wherein the step c) includes the step of c-1) controlling a degree of embedding the watermark using the input audio signal and the discrete wavelet transformed signal.

15. The method of claim 14, wherein in the step c-1), the embedding degree is adjusted using a ratio between an energy of the audio signal and an energy of a high frequency signal in a lowest coefficient by the discrete wavelet transform.

16. The method of claim 13, wherein the mean value of the wavelet coefficients in the step b) is a mean value of lowest subband coefficients of the wavelet coefficient.

17. The method of claim 13, further comprising the step of d) inserting an additional signal into the watermark for detecting a synchronization of the inserted watermark, and transferring the watermark to the step c).

18. The method of claim 17, wherein in the step d), the watermark is repeated and the additional signal is inserted between the watermarks.

19. A method for extracting a wavelet based audio watermark comprising the steps of:
a) receiving a watermarked audio signal and searching a synchronization point;
b) extracting inserted information from the watermarked audio signal using a mean of wavelet coefficients by discrete wavelet transform of the watermarked audio signal having the searched synchronization point; and
c) decoding a watermark using the extracted information.

20. The method of claim 19, wherein in the step a), the synchronization point is searched using information about adjacent frames.

21. The method of claim 20, wherein the information about the adjacent frames is information about a combination of mean and variance of wavelet coefficients of an insertion region of the adjacent frame.

22. The method of claim 19, wherein the mean of the wavelet coefficients in the step a) is a mean of lowest subband wavelet coefficients.

23. The method of claim 19, wherein in the step c), the watermark is extracted using difference information of extracted values between adjacent frames.

24. A copyright management system using an apparatus for embedding and extracting a wavelet based audio watermark, comprising:
a watermark embedding apparatus for embedding the watermark into the audio signal by changing a mean value of wavelet coefficients according to a watermark by performing a discrete wavelet transform on an audio signal which is divided into small signals with a regular length; and
a watermark extracting apparatus for searching a synchronization point of a watermarked audio signal, extracting inserted information using a mean of wavelet coefficients by wavelet transforming the watermarked audio signal, and decoding a watermark using the extracted information.

25. The copyright management system of claim 24, wherein the mean value of the wavelet coefficients is a mean value of lowest subband coefficients.

26. The copyright management system of claim 24, wherein the watermark embedding apparatus controls a degree of embedding the watermark using the input audio signal and the wavelet transformed audio signal.

27. The copyright management system of claim 24, wherein an additional signal is inserted for detecting a synchronization of the inserted watermark, and transferring the watermark to the inserting unit.

28. The copyright management system of claim 24, wherein the watermark extracting apparatus searches a synchronization point using information about adjacent frames.

29. The copyright management system of claim 28, wherein the information of the adjacent frames is information about a combination of mean and variance of wavelet coefficients of an insertion region of the adjacent frame.

30. The copyright management system of claim 24, wherein the decoding of the watermark extracts the watermark using different information of extracted values from the adjacent frames.
